(19) United States
(12) Patent Application Publication
(10) Pub. No.: US 2012/0327851 A1
(43) Pub. Date: Dec. 27, 2012

(54) METHOD AND APPARATUS FOR TUNNELED DIRECT LINK SETUP (TDLS) FOR ESTABLISHING BASIC SERVICE SET

(75) Inventors: Maarten Menzo Wentink, Naarden (NL); Jouni Malinen, Tampere (FI)

(73) Assignee: Qualcomm Incorporated, San Diego, CA (US)

(21) Appl. No.: 13/480,332

(22) Filed: May 24, 2012

Related U.S. Application Data
(60) Provisional application No. 61/491,090, filed on May 27, 2011.
(60) Provisional application No. 61/493,188, filed on Jun. 3, 2011.
(60) Provisional application No. 61/494,442, filed on Jun. 8, 2011.
(60) Provisional application No. 61/496,987, filed on Jun. 14, 2011.

(51) Int. Cl. H04W 4/00

(52) U.S. Cl. 370/328

(57) ABSTRACT

Certain aspects of the present disclosure relate to a technique for establishing a direct link between a pair of apparatuses (e.g., stations or access terminals), and setting up a basic service set of the apparatuses via the direct link. An apparatus in the pair can communicate with another apparatus in the pair through a device (e.g., an access point) in a first bandwidth, establish the direct link with the other apparatus in the first bandwidth, and communicate directly with the other apparatus in a second bandwidth different than the first bandwidth, wherein the apparatus and the other apparatus form the basic service set operating in the second bandwidth.

### CLAIM OF PRIORITY UNDER 35 U.S.C. §119

The present Application for Patent claims benefit of U.S. Provisional Patent Application Ser. No. 61/491,090, filed May 27, 2011, U.S. Provisional Patent Application Ser. No. 61/493,188, filed Jun. 3, 2011, U.S. Provisional Patent Application Ser. No. 61/494,442, filed Jun. 8, 2011, and U.S. Provisional Patent Application Ser. No. 61/496,987, filed Jun. 14, 2011 and assigned to the assignee hereof and hereby expressly incorporated by reference herein.

### BACKGROUND

1. Field

Certain aspects of the present disclosure generally relate to wireless communications and, more particularly, to a method for establishing a Tunneled Direct Link Setup (TDLS) between a pair of apparatuses and setting up a personal basic service set (PBSS) of the apparatuses via the TDLS.

2. Background

In order to address the issue of increasing bandwidth requirements that are demanded for wireless communications systems, different schemes are being developed to allow multiple user terminals to communicate with a single access point by sharing channel resources while achieving high data throughputs. Multiple Input Multiple Output (MIMO) technology represents one such approach that has recently emerged as a popular technique for the next generation communication systems. MIMO technology has been adopted in several emerging wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

The IEEE 802.11 WLAN standards body established specifications for transmissions based on an approach using a carrier frequency of 60 GHz (i.e., the IEEE 802.11ad specification) targeting aggregate throughputs larger than 1 Gigabits per second.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single Access Point (AP) and multiple user stations (STAs), concurrent transmissions may occur on multiple channels toward different stations, both in the uplink and downlink direction. Many challenges are present in such systems.

### SUMMARY

Certain aspects of the present disclosure provide an apparatus for wireless communications. The apparatus generally includes a first circuit configured to communicate with another apparatus through a device in a first bandwidth, a second circuit configured to establish a direct link with the other apparatus in the first bandwidth, a third circuit configured to communicate directly with the other apparatus in a second bandwidth different than the first bandwidth, wherein the apparatus and the other apparatus form a basic service set operating in the second bandwidth, a fourth circuit configured to determine a controller of the basic service set that initiates establishing the direct link, and a fifth circuit configured to include at least one of a Personal basic service set Control Point (PCP) intent field, or tie-breaker fields into a plurality of messages exchanged during establishing the direct link, wherein the determination is based on the at least one of PCP intent field or tie-breaker fields.

Certain aspects of the present disclosure provide a method for wireless communications by an apparatus. The method generally includes communicating with another apparatus through a device in a first bandwidth, establishing a direct link with the other apparatus in the first bandwidth, and communicating directly with the other apparatus in a second bandwidth different than the first bandwidth, wherein the apparatus and the other apparatus form a basic service set operating in the second bandwidth.

Certain aspects of the present disclosure provide an apparatus for wireless communications. The apparatus generally includes means for communicating with another apparatus through a device in a first bandwidth, means for establishing a direct link with the other apparatus in the first bandwidth, and means for communicating directly with the other apparatus in a second bandwidth different than the first bandwidth, wherein the apparatus and the other apparatus form a basic service set operating in the second bandwidth.

Certain aspects of the present disclosure provide a computer-program product for wireless communications by an apparatus. The computer-program product includes a computer-readable medium comprising instructions executable to communicate with another apparatus through a device in a first bandwidth, establish a direct link with the other apparatus in the first bandwidth, and communicate directly with the other apparatus in a second bandwidth different than the first bandwidth, wherein the apparatus and the other apparatus form a basic service set operating in the second bandwidth.

Certain aspects of the present disclosure provide an access terminal. The access terminal generally includes at least one antenna, a first circuit configured to communicate, via the at least one antennas, with another access terminal through an access point in a first bandwidth, a second circuit configured to establish a direct link with the other access terminal in the first bandwidth, and a third circuit configured to communicate directly with the other access terminal in a second bandwidth different than the first bandwidth via the at least one antenna, wherein the access terminal and the other access terminal form a basic service set operating in the second bandwidth.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of a wireless communications network in accordance with certain aspects of the present disclosure.

FIG. 2 illustrates a block diagram of an example access point and user terminals in accordance with certain aspects of the present disclosure.

FIG. 3 illustrates a block diagram of an example wireless device in accordance with certain aspects of the present disclosure.

FIG. 4 illustrates an example frame exchanges in accordance with certain aspects of the present disclosure.

FIG. 5 illustrates example operations that may be performed at a wireless station in accordance with certain aspects of the present disclosure.

FIG. 5A illustrates example components capable of performing the operations shown in FIG. 5.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are created in the frequency domain with OFDM and in the time domain with SC-FDMA. A SC-FDMA system may implement 3GPP-LTE (3^{rd} Generation Partnership Project Long Term Evolution) or some other standards known in the art.

The teachings herein may be incorporated into (e.g., implemented within or performed by) a variety of wired or wireless apparatuses (e.g., nodes). In some aspects a node comprises a wireless node. Such wireless node may provide, for example, connectivity for or to a network (e.g., a wide area network such as the Internet or a cellular network) via a wired or wireless communication link. In some aspects, a wireless node implemented in accordance with the teachings herein may comprise an access point or an access terminal.

An access point (“AP”) may comprise, be implemented as, or known as NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology. In some implementations an access point may comprise a set top box kiosk, a media center, or any other suitable device that is configured to communicate via a wireless or wired medium. According to certain aspects of the present disclosure, the access point may operate in accordance with the Institute of Electrical and Electronics Engineers (IEEE) 802.11 family of wireless communications standards.

An access terminal (“AT”) may comprise, be implemented as, or known as an access terminal, a subscriber station, a subscriber unit, a mobile station, a remote station, a remote terminal, a user terminal, a user agent, a user device, user equipment, a user station, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), a tablet, an entertainment device (e.g., a music or video device, or a satellite radio), a television display, a flip-cam, a security video camera, a digital video recorder (DVR), a global positioning system device, or any other suitable device that is configured to communicate via a wireless or wired medium. According to certain aspects of the present disclosure, the access terminal may operate in accordance with the IEEE 802.11 family of wireless communications standards.

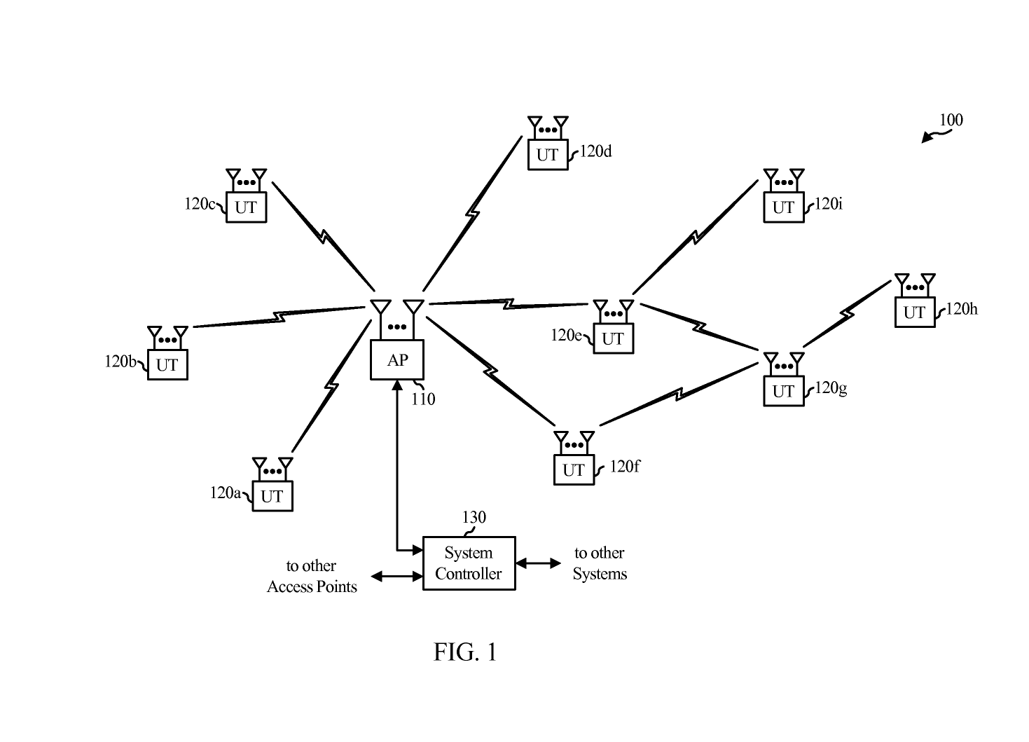

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of sub-bands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The SDMA system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

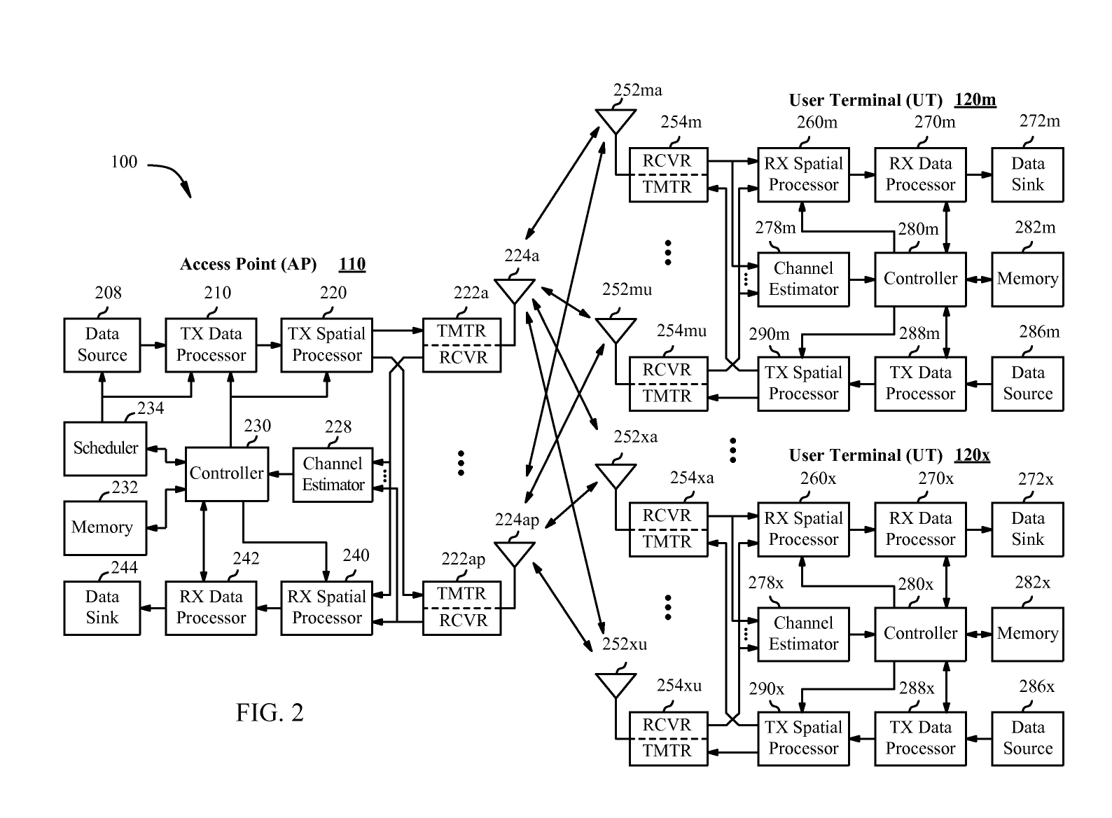

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

For certain aspects of the present disclosure, the wireless system 100 illustrated in FIGS. 1-2 may operate in accordance with IEEE 802.11ad wireless communications standard utilizing a carrier frequency of 60 GHz.

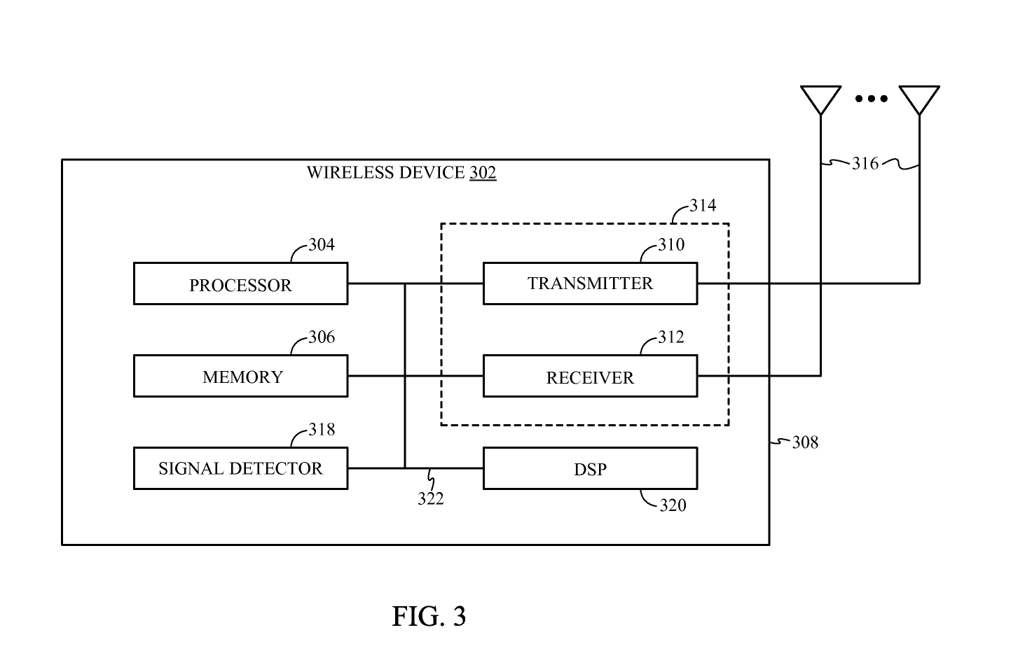

FIG. 3 illustrates various components that may be utilized in a wireless device 302 that may be employed within the wireless communication system 100. The wireless device 302 is an example of a device that may be configured to implement the various methods described herein. The wireless device 302 may, for example, correspond to the access point 110 or to the user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 302 may also include a housing 308 that may include a transmitter 310 and a receiver 312 to allow transmission and reception of data between the wireless device 302 and another wireless node (e.g., another wireless node in a remote location). The transmitter 310 and receiver 312 may be combined into a transceiver 314. Wireless device 302 may also include one or more antennas 316 electrically coupled to the transceiver 314. The wireless device 302 may also include (not shown) multiple transmitters, multiple receivers, multiple transceivers, and/or multiple antennas.

The wireless device 302 may also include a signal detector 318 that may detect and quantify the level of signals received by the transceiver 314. The signal detector 318 may quantify detection of such signals using total energy, energy per subcarrier per symbol, power spectral density and/or other quantification metrics. The wireless device 302 may also include a digital signal processor (DSP) 320 for use in processing signals.

The various components of the wireless device 302 may be coupled by a bus system 322, which may include a power bus, a control signal bus, and a status signal bus in addition to a data bus.

Certain aspects of the present disclosure support a method for establishing a direct link between a pair of apparatuses (e.g., stations or user terminals 120), and setting up a personal basic service set (PBSS) of the user terminals (stations) 120 via the direct link. The direct link may correspond to a communication link directly established between a station and a peer station in a wireless network (e.g., in the network 100 from FIG. 1). Moreover, the wireless network may comprise at least one access point (e.g., the access point 110) that may serve as an intermediary for transmissions between the station and the peer station. Once the PBBS comprising the station and the peer station is set, these peer stations may directly communicate via the direct link without using any additional intermediary communication entity (e.g., the access point). According to certain aspects of the present disclosure, the direct link may comprise a Tunneled Direct Link Setup (TDLS) channel between the station and the peer station, wherein setting up the PBSS may be achieved via the TDLS channel.

### Tunneled Direct Link Setup with 60 GHz

In an aspect, two stations (STAs) (e.g., user terminals 120) may be associated with an access point (e.g., the access point 110) in the 5 GHz band (or 2.5 GHz band). The STAs 120 may be configured to set up a secure TDLS direct link through the access point 110. For example, in this case, it may not be needed to enter a new password to establish communication between these two STAs, i.e., user intervention may not be needed. The direct link may be secure when a basic service set (BSS) comprising the STAs 120 is secured.

The STAs 120 may be configured to switch to the 60 GHz band and start a PBSS. According to certain aspects of the present disclosure, fast session transfer (FST) or TDLS channel switch may be utilized to switch bands (i.e., to switch from 5 GHz to 60 GHz band). In an aspect of the present disclosure, FST messages may be exchanged on the direct link in the 5 GHz band.

It should be noted that switching the bands is where this particular TDLS differs from regular TDLS, which does not form BSS between the STAs. If the DBand beacons or Announcements are not needed, then the PBSS may not be needed. The DBand Beacon and Announcements may be used to convey scheduling information (i.e., semi-persistent (SP) scheduling information).

In an aspect of the present disclosure, a TDLS security key (e.g., a TDLS Peer Key-Temporal Key (TPK-TK)) may be used as the PBSS key between the STAs, in which case the four-way handshake may be skipped when setting up the PBSS. Alternatively, exchanged TDLS nonces (random numbers) may be concatenated and used as a pre-shared key (PSK) in the four-way handshake.

In an aspect of the present disclosure, it may be needed to determine which STA becomes the PBSS Control Point (PCP) in the DBand. This can be performed by adding a Personal basic service set Control Point (PCP) intent field and random tie-breaker fields into the TDLS setup messages. The advantage of this approach may be that a 60 GHz PBSS can be set up without user intervention between STAs associated to the same AP. The same method may be utilized to set up a peer-to-peer (P2P) network between the STAs.

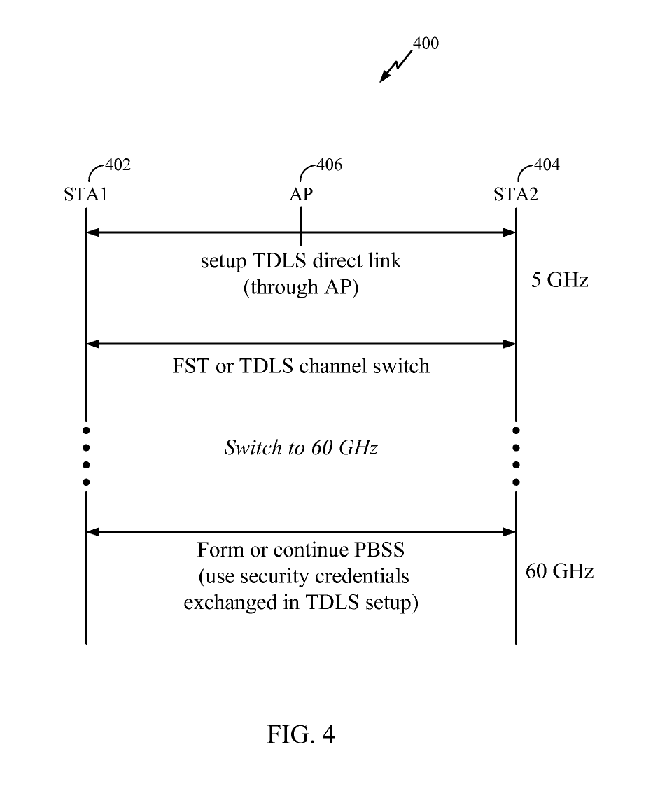

FIG. 4 illustrates an example 400 of frame exchanges for setting up the 60 GHz PBSS in accordance with certain aspects of the present disclosure. A STA 402 may be configured to set up a TDLS direct link with a STA 404 through an access point 406. In an aspect, this communication may be achieved in the 5 GHz bandwidth. Following this, the FST or TDLS channel switch may be performed in order to switch to 60 GHz band. During the switching of bands, FST Setup Request/Response may be exchanged between the STAs 402 and 404.

According to certain aspects of the present disclosure, a STA with a highest Media Access Control (MAC) address, a TDLS initiator, or a STA associated with a random PCP field in combination with PCP intent value may become the PCP of the PBSS. After determining the PCP, Association Request/Response messages may be exchanged between the STAs 402 and 404.

In an aspect of the present disclosure, the four-way handshake may be skipped if a pairwise transient key (PTK) already exists for this association. In another aspect, the STAs 402 and 404 may enter into four-way handshake and use the nonces exchanged in the TDLS handshake as a pair-wise security key.

As illustrated in FIG. 4, after switching to 60 GHz band, the STAs 402, 404 may form a new PBSS or continue an existing PBSS, while security credentials exchanged in the TDLS setup may be utilized.

### Modifications for Galois/Counter Mode Protocol (GCMP)

Utilizing the same TDLS Peer Key-Temporal Key (TPK-TK) for Counter mode with Cipher-block chaining Message authentication code Protocol (CCMP) and Galois/Counter Mode Protocol (GCMP) simultaneously may not be a preferred solution. According to certain aspects of the present disclosure, a second transient key (TPK-TK2) may be derived for the use with GCMP.

In one aspect of the present disclosure, the TPK-TK2 may be derived from the existing TDLS nonces using a different hash of the nonces, and possibly using a different key derivation function (KDF). In another aspect, the TPK-TK2 may be derived based on specific GCMP nonces, which may be added to the TDLS setup request/response frames.

In an aspect of the present disclosure, in order not to exceed the PSK length, the TDLS nonces may be XOR-ed rather than concatenated. This may be applied in case the four-way handshake remains used in setting up the PBSS. For example, the TDLS nonces and the maximum PSK length may be both equal to 256 bits.

In an aspect of the present disclosure, the PSK may be generated by utilizing the TPK-Key-Input as defined in accordance with IEEE 802.11 family of wireless communications standards (e.g., the IEEE 802.11z standard). In particular, the PSK for TDLS and 60 GHz band may be defined as:

PSK=KDF−256(TPK-Key-Input,“TDLS PBSS PSK”,BSSID), (1)

wherein the BSSID denotes an identifier (ID) of the Basic Service Set (BSS). In an aspect, the BSSID may be extended to comprise Media Access Control (MAC) addresses of STAs in the basic service set, as for the TPK-Key-Data derivation.

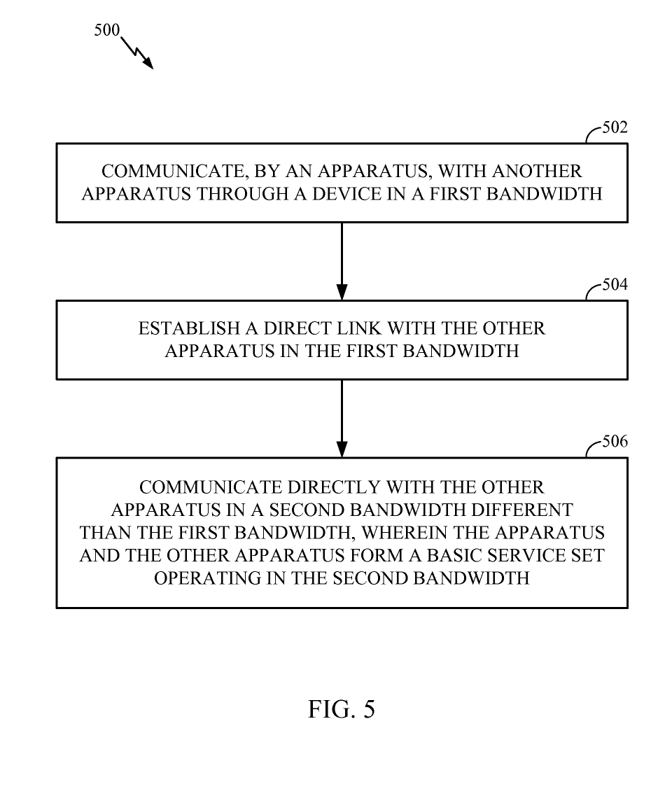

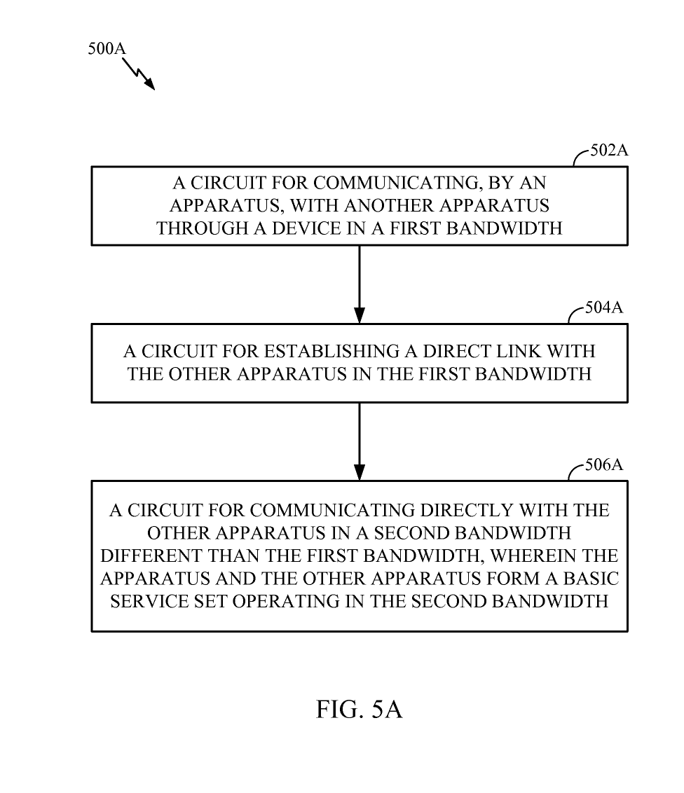

FIG. 5 illustrates example operations 500 that may be performed at a wireless station (STA) in accordance with certain aspects of the present disclosure. At 502, the STA may communicate with another STA through a device (e.g., an access point) in a first bandwidth. At 504, the STA may establish a direct link with the other STA in the first bandwidth. At 506, the STA may communicate directly with the other STA in a second bandwidth different than the first bandwidth, wherein the STA and the other STA may form a basic service set operating in the second bandwidth. In an aspect, the basic service set may comprise a personal basic service set (PBSS). In an aspect, the first bandwidth may comprise 2.5 GHz bandwidth or 5 GHz bandwidth, and the second bandwidth may comprise 60 GHz bandwidth.

In an aspect, the STA may determine a controller of the basic service set. In one aspect of the present disclosure, the direct link may comprise a Tunneled Direct Link Setup (TDLS) communication link, and the controller may comprise a Personal basic service set Control Point (PCP). In another aspect, the basic service set may comprise a peer-to-peer (P2P) communication link, and the controller may comprise a group owner of the P2P network.

In one aspect, the determination of controller may be is based on Media Access Control (MAC) addresses of the STA and the other STA. In another aspect, the controller may be determined such that to comprise a STA that initiates establishing the direct link. In yet another aspect, the determination of controller may comprise adding at least one of PCP intent field, or tie-breaker fields into a plurality of messages exchanged during establishing the direct link. In this case, a first of the tie-breaker fields may be set to 0 or 1 randomly in a Tunneled Direct Link Setup (TDLS) request message of the plurality of messages. Alternatively, a second of the tie-breaker fields may be toggled in a TDLS response field of a TDLS response message of the plurality of messages.

In an aspect, the STA may be configured to switch communication with the other STA from the first bandwidth to the second bandwidth after establishing the direct link. The switching may be based on utilizing a TDLS channel switching. Alternatively, the switching may be based on using FST.

In an aspect, the STAs may continue operating in the basic service set after a period of time, wherein the basic service set may correspond to an existing basic service set previously established.

In an aspect, the STA may use, while communicating directly with the other STA in the second bandwidth, security credentials exchanged during establishing the direct link. In another aspect, the STA may use, while communicating directly with the other STA in the second bandwidth, a security key derived during establishing the direct link. In this case, the STA may use the derived security key while establishing the basic service set instead of a four-way handshake with the other STA.

In an aspect, the derived security key may be different from a Tunneled direct link setup Peer Key-Temporal Key (TPK-TK). Random numbers may be included in messages (e.g., request/response messages) exchanged during establishing the direct link for deriving the security key used while establishing the basic service set.

In an aspect, the STA may use a pre-shared security key when setting up the direct communication with the other STA in the second bandwidth. In another aspect, the STA may be exchanging random numbers with the other STA using the direct link. After concatenating the random numbers, the STA may use the concatenated random numbers as a pre-shared security key when setting up the direct communication with the other STA in the second bandwidth. Alternatively, the STA may perform a binary operation on the random numbers to obtain a random value. After that, the STA may use the random value as a pre-shared security key when setting up the direct communication with the other STA in the second bandwidth. For example, the binary operation may comprise an exclusive OR (XOR) operation between the random numbers.

According to certain aspects of the present disclosure, a PTK used for the direct communication with the other STA in the second bandwidth may be generated at the STA based on an extension of Tunneled direct link setup Pairwise Key (TPK)-Key-Data. In an aspect, the PTK may be generated based on the TPK-Key-Data extended with 256 bits. In another aspect, an N_KEY used for derivation of the TPK-Key-Data may be based on a Temporal Key (TK). For example, the N_KEY may be equal to TK_bits+128+256. In yet another aspect, the PTK may be derived from a portion of bits of the TPK-Key-Data (e.g., from last 256 bits of the TPK-Key-Data).

In an aspect, the STA may generate a pre-shared security key used when setting up the direct communication with the other STA in the second bandwidth, wherein the pre-shared security key may be generated based on at least one of a Key Derivation Function (KDF), a Tunneled direct link setup Peer Key (TPK) Key Input defined in accordance with IEEE 802.11 family of wireless communications standards, a Tunneled Direct Link Setup Personal Basic Service Set Pre-Shared Key (TDLS PBSS PSK), or an identifier (ID) of the basic service set.

FIG. 5A illustrates example operations 500A that may be performed at a wireless STA (e.g., at the user terminal 120 and/or at the wireless device 302) in accordance with certain aspects of the present disclosure. At 502A, a first circuit (e.g., the transceiver 254 and/or the transceiver 314) of the STA may be configured to establish communication between the STA and another STA (e.g., another user terminal 120 and/or another wireless device 302) through an access point (e.g., the access point 110) in a first bandwidth. At 504A, a second circuit (e.g., the transceiver 254 and/or the transceiver 314) of the STA may be configured to establish a direct link between the STA and the other STA in the first bandwidth. At 506A, a third circuit (e.g., the transceiver 254 and/or the transceiver 314) of the STA may be configured to provide direct communication between the STA and the other STA in a second bandwidth different than the first bandwidth, wherein the STA and the other STA may form a basic service set operating in the second bandwidth. In an aspect, a fourth circuit (e.g., the transceiver 254 and/or the transceiver 314) of the STA may be configured to switch, after establishing the direct link, communication with the other STA from the first bandwidth to the second bandwidth using a TDLS channel switching or a fast session transfer.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering. For example, operations 500 illustrated in FIG. 5 correspond to components 500A illustrated in FIG. 5A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Means for communicating may comprise one or more modules and/or circuits of an apparatus configured to perform communication between the apparatus and another apparatus. In an aspect, the means for communicating may comprise a transceiver, e.g., the transceiver 254 from FIG. 2 of the user terminal 120 from FIG. 1 or the transceiver 314 of the wireless device 302 from FIG. 3. Means for establishing may comprise one or more modules and/or circuits of an apparatus configured to establish a link between the apparatus and another apparatus. In an aspect, the means for establishing may comprise an application specific integrated circuit, e.g., the processor 270 from FIG. 2 of the user terminal 120, the processor 288 from FIG. 2 of the user terminal 120, or the processor 304 of the wireless device 302. Means for determining may comprise one or more modules and/or circuits of an apparatus configured to determine a controller of a basic service set that initiates establishing a link between the apparatus and another apparatus. In an aspect, the means for determining may comprise an application specific integrated circuit, e.g., the processor 270, the processor 288, or the processor 304. Means for including may comprise one or more modules and/or circuits of an apparatus configured to include one or more fields into messages exchanged during establishing a link between the apparatus and another apparatus. In an aspect, the means for including may comprise an application specific integrated circuit, e.g., the processor 270, the processor 288, or the processor 304. Means for switching may comprise one or more modules and/or circuits of an apparatus configured to switch communication between the apparatus and another apparatus from a first bandwidth to a second bandwidth. In an aspect, the means for switching may comprise an application specific integrated circuit, e.g., the processor 270, the processor 288, or the processor 304.

Means for using security credentials or a security key may comprise one or more modules and/or circuits of an apparatus configured to use the security credentials exchanged during establishing a link between the apparatus and another apparatus and to use the security key derived during establishing the link. In an aspect, the means for using the security credentials or the security key may comprise an application specific integrated circuit, e.g., the processor 270, the processor 288, or the processor 304. Means for using the derived security key may comprise one or more modules and/or circuits of an apparatus configured to use the derived security key to establish a basic service set comprising the apparatus and another apparatus. In an aspect, the means for using the derived security key may comprise an application specific integrated circuit, e.g., the processor 270, the processor 288, or the processor 304. Means for using a pre-shared security key may comprise one or more modules and/or circuits of an apparatus configured to use the pre-shared security key when setting up communication between the apparatus and the other apparatus. In an aspect, the means for using the pre-shared security key may comprise an application specific integrated circuit, e.g., the processor 270, the processor 288, or the processor 304.

Means for exchanging random numbers may comprise one or more modules and/or circuits of an apparatus configured to exchange random numbers between the apparatus and another apparatus using a direct link between the apparatus and the other apparatus. In an aspect, the means for exchanging random numbers may comprise an application specific integrated circuit, e.g., the processor 270, the processor 288, or the processor 304. Means for concatenating may comprise one or more modules and/or circuits configured to concatenate the random numbers. In an aspect, the means for concatenating may comprise an application specific integrated circuit, e.g., the processor 270, the processor 288, or the processor 304. Means for using the concatenated random numbers may comprise one or more modules and/or circuits of an apparatus configured to use the concatenated random numbers as a pre-shared security key when setting up direct communication between the apparatus and the other apparatus. In an aspect, the means for using the concatenated random numbers may comprise an application specific integrated circuit, e.g., the processor 270, the processor 288, or the processor 304. Means for performing may comprise one or more modules and/or circuits configured to perform a binary operation on random numbers to obtain a random value. In an aspect, the means for performing may comprise an application specific integrated circuit, e.g., the processor 270, the processor 288, or the processor 304. Means for using the random value may comprise one or more modules and/or circuits of an apparatus configured to use the random value as a pre-shared security key when setting up direct communication between the apparatus and the other apparatus. In an aspect, the means for using the random value may comprise an application specific integrated circuit, e.g., the processor 270, the processor 288, or the processor 304. Means for generating may comprise one or more modules and/or circuits of an apparatus configured to generate a pre-shared security key used when setting up direct communication between the apparatus and another apparatus. In an aspect, the means for generating may comprise an application specific integrated circuit, e.g., the processor 270, the processor 288, or the processor 304.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1. An apparatus for wireless communications, comprising:
a first circuit configured to communicate with another apparatus through a device in a first bandwidth;
a second circuit configured to establish a direct link with the other apparatus in the first bandwidth; and
a third circuit configured to communicate directly with the other apparatus in a second bandwidth different than the first bandwidth, wherein the apparatus and the other apparatus form a basic service set operating in the second bandwidth.

2. The apparatus of claim 1, further comprising:
a fourth circuit configured to determine a controller of the basic service set that initiates establishing the direct link.

3. The apparatus of claim 2, wherein:
the basic service set comprises a personal basic service set (PBSS),
the direct link comprises a Tunneled Direct Link Setup (TDLS) communication link, and
the controller comprises a Personal basic service set Control Point (PCP) of the PBSS.

4. The apparatus of claim 2, wherein:
the basic service set comprises a peer-to-peer (P2P) communication link; and
the controller comprises a group owner.

5. The apparatus of claim 2, wherein the determination is based on Media Access Control (MAC) addresses of the apparatus and the other apparatus.

6. The apparatus of claim 2, further comprising:
a fifth circuit configured to include at least one of a Personal basic service set Control Point (PCP) intent field or tie-breaker fields into a plurality of messages exchanged during establishing the direct link, wherein
the determination is based on the at least one of PCP intent field or tie-breaker fields.

7. The apparatus of claim 6, wherein:
a first of the tie-breaker fields is set to 0 or 1 randomly in a Tunneled Direct Link Setup (TDLS) request message of the plurality of messages, or
a second of the tie-breaker fields is toggled in a TDLS response field of a TDLS response message of the plurality of messages.

8. The apparatus of claim 1, wherein:
the first bandwidth comprises 2.5 GHz bandwidth or 5 GHz bandwidth, and
the second bandwidth comprises 60 GHz bandwidth.

9. The apparatus of claim 1, further comprising:
a fourth circuit configured to switch, after establishing the direct link, communication with the other apparatus from the first bandwidth to the second bandwidth using a Tunneled Direct Link Setup (TDLS) channel switching or a fast session transfer (FST).

10. The apparatus of claim 1, wherein the third circuit is also configured to:
use, while communicating directly with the other apparatus in the second bandwidth, security credentials exchanged during establishing the direct link or a security key derived during establishing the direct link.

11. The apparatus of claim 10, further comprising:
a fourth circuit configured to use the derived security key to establish the basic service set.

12. The apparatus of claim 10, wherein the derived security key is different from a Tunneled direct link setup Peer Key-Temporal Key (TPK-TK).

13. The apparatus of claim 10, wherein random numbers are included in messages exchanged during establishing the direct link for deriving the security key used while establishing the basic service set.

14. The apparatus of claim 1, wherein the third circuit is also configured to:
use a pre-shared security key when setting up the direct communication with the other apparatus in the second bandwidth.

15. The apparatus of claim 1, wherein the third circuit is also configured to:
exchange random numbers with the other apparatus using the direct link;
concatenate the random numbers; and
use the concatenated random numbers as a pre-shared security key when setting up the direct communication with the other apparatus in the second bandwidth.

16. The apparatus of claim 1, wherein the third circuit is also configured to:
exchange random numbers with the other apparatus using the direct link;
perform a binary operation on the random numbers to obtain a random value; and
use the random value as a pre-shared security key when setting up the direct communication with the other apparatus in the second bandwidth.

17. The apparatus of claim 1, wherein the third circuit is also configured to:
generate a pre-shared security key used when setting up the direct communication with the other apparatus in the second bandwidth, and
wherein the pre-shared security key is generated based on at least one of a Key Derivation Function (KDF), a Tunneled direct link setup Peer Key (TPK) Key Input defined in accordance with IEEE 802.11 family of wireless communications standards, a Tunneled Direct Link Setup Personal Basic Service Set Pre-Shared Key (TDLS PBSS PSK), or an identifier (ID) of the basic service set.

18. The apparatus of claim 17, wherein the ID of the basic service set comprises Media Access Control (MAC) addresses of the apparatus and the other apparatus.

19. The apparatus of claim 1, further comprising:
a fourth circuit configured to generate a pairwise transient key (PTK) used for the direct communication with the other apparatus in the second bandwidth, wherein
the PTK is generated based on an extension of Tunneled direct link setup Pairwise Key (TPK)-Key-Data, or based on a portion of bits of the TPK-Key-Data.

20. The apparatus of claim 19, wherein derivation of the TPK-Key-Data is based on a Temporal Key (TK).

21. A method for wireless communications by an apparatus, comprising:
communicating with another apparatus through a device in a first bandwidth;
establishing a direct link with the other apparatus in the first bandwidth; and
communicating directly with the other apparatus in a second bandwidth different than the first bandwidth, wherein the apparatus and the other apparatus form a basic service set operating in the second bandwidth.

22. The method of claim 21, further comprising:
determining a controller of the basic service set that initiates establishing the direct link.

23. The method of claim 22, wherein:
the basic service set comprises a personal basic service set (PBSS),
the direct link comprises a Tunneled Direct Link Setup (TDLS) communication link, and
the controller comprises a Personal basic service set Control Point (PCP) of the PBSS.

24. The method of claim 22, wherein:
the basic service set comprises a peer-to-peer (P2P) communication link; and
the controller comprises a group owner.

25. The method of claim 22, wherein the determination is based on Media Access Control (MAC) addresses of the apparatus and the other apparatus.

26. The method of claim 22, further comprising:
including at least one of a Personal basic service set Control Point (PCP) intent field or tie-breaker fields into a plurality of messages exchanged during establishing the direct link, wherein
the determination is based on the at least one of PCP intent field or tie-breaker fields.

27. The method of claim 26, wherein:
a first of the tie-breaker fields is set to 0 or 1 randomly in a Tunneled Direct Link Setup (TDLS) request message of the plurality of messages, or
a second of the tie-breaker fields is toggled in a TDLS response field of a TDLS response message of the plurality of messages.

28. The method of claim 21, wherein:
the first bandwidth comprises 2.5 GHz bandwidth or 5 GHz bandwidth, and
the second bandwidth comprises 60 GHz bandwidth.

29. The method of claim 21, further comprising:
switching, after establishing the direct link, communication with the other apparatus from the first bandwidth to the second bandwidth using a Tunneled Direct Link Setup (TDLS) channel switching or a fast session transfer (FST).

30. The method of claim 21, further comprising:
using, while communicating directly with the other apparatus in the second bandwidth, security credentials exchanged during establishing the direct link or a security key derived during establishing the direct link.

31. The method of claim 30, further comprising:
using the derived security key to establish the basic service set.

32. The method of claim 30, wherein the derived security key is different from a Tunneled direct link setup Peer Key-Temporal Key (TPK-TK).

33. The method of claim 30, wherein random numbers are included in messages exchanged during establishing the direct link for deriving the security key used while establishing the basic service set.

34. The method of claim 21, further comprising:
using a pre-shared security key when setting up the direct communication with the other apparatus in the second bandwidth.

35. The method of claim 21, further comprising:
exchanging random numbers with the other apparatus using the direct link;
concatenating the random numbers; and
using the concatenated random numbers as a pre-shared security key when setting up the direct communication with the other apparatus in the second bandwidth.

36. The method of claim 21, further comprising:
exchanging random numbers with the other apparatus using the direct link;
performing a binary operation on the random numbers to obtain a random value; and
using the random value as a pre-shared security key when setting up the direct communication with the other apparatus in the second bandwidth.

37. The method of claim 21, further comprising:
generating a pre-shared security key used when setting up the direct communication with the other apparatus in the second bandwidth,
wherein the pre-shared security key is generated based on at least one of a Key Derivation Function (KDF), a Tunneled direct link setup Peer Key (TPK) Key Input defined in accordance with IEEE 802.11 family of wireless communications standards, a Tunneled Direct Link Setup Personal Basic Service Set Pre-Shared Key (TDLS PBSS PSK), or an identifier (ID) of the basic service set.

38. The method of claim 37, wherein the ID of the basic service set comprises Media Access Control (MAC) addresses of the apparatus and the other apparatus.

39. The method of claim 21, further comprising:
generating a pairwise transient key (PTK) used for the direct communication with the other apparatus in the second bandwidth, wherein
the PTK is generated based on an extension of Tunneled direct link setup Pairwise Key (TPK)-Key-Data, or based on a portion of bits of the TPK-Key-Data.

40. The method of claim 39, wherein derivation of the TPK-Key-Data is based on a Temporal Key (TK).

41. An apparatus for wireless communications, comprising:
means for communicating with another apparatus through a device in a first bandwidth;
means for establishing a direct link with the other apparatus in the first bandwidth; and
means for communicating directly with the other apparatus in a second bandwidth different than the first bandwidth, wherein the apparatus and the other apparatus form a basic service set operating in the second bandwidth.

42. The apparatus of claim 41, further comprising:
means for determining a controller of the basic service set that initiates establishing the direct link.

43. The apparatus of claim 42, wherein:
the basic service set comprises a personal basic service set (PBSS),
the direct link comprises a Tunneled Direct Link Setup (TDLS) communication link, and
the controller comprises a Personal basic service set Control Point (PCP) of the PBSS.

44. The apparatus of claim 42, wherein:
the basic service set comprises a peer-to-peer (P2P) communication link; and
the controller comprises a group owner.

45. The apparatus of claim 42, wherein the determination is based on Media Access Control (MAC) addresses of the apparatus and the other apparatus.

46. The apparatus of claim 42, further comprising:
means for including at least one of a Personal basic service set Control Point (PCP) intent field or tie-breaker fields into a plurality of messages exchanged during establishing the direct link, wherein
the determination is based on the at least one of PCP intent field or tie-breaker fields.

47. The apparatus of claim 46, wherein:
a first of the tie-breaker fields is set to 0 or 1 randomly in a Tunneled Direct Link Setup (TDLS) request message of the plurality of messages, or
a second of the tie-breaker fields is toggled in a TDLS response field of a TDLS response message of the plurality of messages.

48. The apparatus of claim 41, wherein:
the first bandwidth comprises 2.5 GHz bandwidth or 5 GHz bandwidth, and
the second bandwidth comprises 60 GHz bandwidth.

49. The apparatus of claim 41, further comprising:
means for switching, after establishing the direct link, communication with the other apparatus from the first bandwidth to the second bandwidth using a Tunneled Direct Link Setup (TDLS) channel switching or a fast session transfer (FST).

50. The apparatus of claim 41, further comprising:
means for using, while communicating directly with the other apparatus in the second bandwidth, security credentials exchanged during establishing the direct link or a security key derived during establishing the direct link.

51. The apparatus of claim 50, further comprising:
means for using the derived security key to establish the basic service set.

52. The apparatus of claim 50, wherein the derived security key is different from a Tunneled direct link setup Peer Key-Temporal Key (TPK-TK).

53. The apparatus of claim 50, wherein random numbers are included in messages exchanged during establishing the direct link for deriving the security key used while establishing the basic service set.

54. The apparatus of claim 41, further comprising:
means for using a pre-shared security key when setting up the direct communication with the other apparatus in the second bandwidth.

55. The apparatus of claim 41, further comprising:
means for exchanging random numbers with the other apparatus using the direct link;
means for concatenating the random numbers; and
means for using the concatenated random numbers as a pre-shared security key when setting up the direct communication with the other apparatus in the second bandwidth.

56. The apparatus of claim 41, further comprising:
means for exchanging random numbers with the other apparatus using the direct link;
means for performing a binary operation on the random numbers to obtain a random value; and
means for using the random value as a pre-shared security key when setting up the direct communication with the other apparatus in the second bandwidth.

57. The apparatus of claim 41, further comprising:
means for generating a pre-shared security key used when setting up the direct communication with the other apparatus in the second bandwidth,
wherein the pre-shared security key is generated based on at least one of a Key Derivation Function (KDF), a Tunneled direct link setup Peer Key (TPK) Key Input defined in accordance with IEEE 802.11 family of wireless communications standards, a Tunneled Direct Link Setup Personal Basic Service Set Pre-Shared Key (TDLS PBSS PSK), or an identifier (ID) of the basic service set.

58. The apparatus of claim 57, wherein the ID of the basic service set comprises Media Access Control (MAC) addresses of the apparatus and the other apparatus.

59. The apparatus of claim 41, further comprising:
means for generating a pairwise transient key (PTK) used for the direct communication with the other apparatus in the second bandwidth, wherein
the PTK is generated based on an extension of Tunneled direct link setup Pairwise Key (TPK)-Key-Data, or based on a portion of bits of the TPK-Key-Data.

60. The apparatus of claim 59, wherein derivation of the TPK-Key-Data is based on a Temporal Key (TK).

61. A computer-program product for wireless communications by an apparatus, comprising a computer-readable medium comprising instructions executable to:
communicate with another apparatus through a device in a first bandwidth;
establish a direct link with the other apparatus in the first bandwidth; and
communicate directly with the other apparatus in a second bandwidth different than the first bandwidth, wherein the apparatus and the other apparatus form a basic service set operating in the second bandwidth.

62. An access terminal, comprising:
at least one antenna;
a first circuit configured to communicate, via the at least one antenna, with another access terminal through an access point in a first bandwidth;
a second circuit configured to establish a direct link with the other access terminal in the first bandwidth; and
a third circuit configured to communicate directly with the other access terminal in a second bandwidth different than the first bandwidth via the at least one antenna, wherein the access terminal and the other access terminal form a basic service set operating in the second bandwidth.
